(19) United States
(12) Patent Application Publication
(10) Pub. No.: US 2016/0148271 A1
(43) Pub. Date: May 26, 2016

(54) Personalized Marketing Based on Sequence Mining

(71) Applicant: Adobe Systems Incorporated, San Jose, CA (US)

(72) Inventors: Ritwik Sinha, Kolkata (IN); Tapan Bohra, Kota (IN); Sanket Vaibhav Mehta, Pune (IN); Adit Krishnan, Chennai (IN)

(21) Appl. No.: 14/548,684

(22) Filed: Nov. 20, 2014

(51) Int. Cl. G06Q 30/02

(52) U.S. Cl. CPC G06Q 30/0269

(57) ABSTRACT

Techniques to personalize a sequence of marketing actions and/or marketing channels used to contact individuals are described herein. Marketing data may be analyzed to select a sequence of marketing actions to employ for targeted marketing to an individual user. The analysis involves a comparison of sequence data obtained from collected marketing data that describes sequencing for the marketing offers provided to consumers to one or more potential sequences for the individual user. The potential sequences may be ranked based on similarities in characteristics of consumers associated with sequences that achieved a designated objective and the individual user's marketing sequence. Characteristics used for the ranking may further include demographic details and behavioral information regarding the consumers and individual user. One or more top ranking sequences are identified and employed to determine one or more marketing actions to perform next to provide targeted marketing offers to the individual user.

### BACKGROUND

As consumer interaction with online resources (e.g., use of web resources, e-commerce, browsing activity, etc.) has grown digital marketing too has becoming increasingly more common. Generally, digital marketers seek to deliver offers for products, services, and content to consumers who will find the offers favorable and have a high probability of responding to the offers. Accordingly, one challenge faced by digital marketers is matching of offers to users so as to maximize the likelihood that users will accept the offers and accordingly optimize the return/reward to the digital marketers derived from the offers.

Traditionally, marketing schemes and corresponding offer selections are largely targeted to groups of users having similar characteristics with little or no personalization on an individual level. This is particularly true with respect to the sequence of interactions and marketing channels (e.g., social contact, email, marketing call, display ads, etc.) that are used to contact consumers. Traditional marketing schemes often use the same fixed sequence of interactions over and over again with different consumers and do not vary the marketing schemes. By neglecting to consider ways in which a sequence of interactions and marketing channels may be tailored to individual users, traditional approaches may not adequately achieve maximization of long-term objectives, such as for revenue, satisfaction, offer acceptance, and so forth.

### SUMMARY

Techniques to personalize a sequence of marketing actions and/or marketing channels used to contact individuals are described herein. In one or more implementations, a digital marketing environment includes a service for management of digital marketing campaigns that operates to individualize marketing actions taken with respect to different consumers. To do so, marketing data is collected that is indicative of interactions of consumers with online marketing offers. The marketing data is analyzed to select a sequence of marketing actions to employ for targeted marketing to an individual user. The analysis involves a comparison of sequence data obtained from the collected marketing data that describes sequencing for the marketing offers provided to the consumers to one or more potential sequences for the individual user. The analysis is focused upon potential sequences that include a sequence of marketing actions already engaged in with the individual user. In one approach, potential sequences are ranked based on similarities in characteristics of consumers associated with sequences that achieved a designated objective and the individual user. Characteristics used for the ranking include either or both of demographic details and behavioral information regarding the consumers and individual user. One or more top ranking sequences are identified and employed to determine one or more marketing actions to perform next to provide targeted marketing offers to the individual user.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the following discussion.

FIG. 1 is an illustration of an example operating environment that is operable to employ techniques for personalized marketing based on sequence mining.

FIG. 2 is a diagram depicting an example scenario for personalized marketing based on sequence mining in accordance with one or more implementations.

FIG. 3 is a diagram depicting details of an example prediction model in accordance with one or more implementations.

FIG. 4 depicts an example algorithm for personalized marketing based on sequence mining in accordance with one or more implementations.

FIG. 5 is a flow diagram depicting an example procedure in which sequence data is used to select marketing actions in accordance with one or more implementations.

FIG. 6 is a flow diagram depicting an example procedure in which a prediction model is applied to rank potential sequences and ascertain marketing actions to perform in accordance with one or more implementations.

FIG. 7 illustrates an example system, devices, and components that can be employed to implement aspects of the techniques described herein.

### DETAILED DESCRIPTION

Overview

Traditionally, marketing schemes and corresponding offer selections are largely targeted to groups of users having similar characteristics with little or no personalization on an individual level. For example, traditional marketing schemes often use the same fixed sequence of marketing interactions over and over again with different consumers and do not vary the marketing schemes. By neglecting to consider ways in which a sequence of interactions and marketing channels may be tailored to individual users, traditional approaches may not adequately achieve maximization of long-term objectives, such as for revenue, satisfaction, offer acceptance, and so forth.

Techniques to personalize a sequence of marketing actions and/or marketing channels used to contact individuals are described herein. In one or more implementations, a digital marketing environment includes a service for management of digital marketing campaigns that operates to individualize marketing actions taken with respect to different consumers. To do so, marketing data is collected that is indicative of interactions of consumers with online marketing offers. The analysis involves a comparison of sequence data obtained from the collected marketing data that describes sequencing for the marketing offers provided to the consumers to one or more potential sequences for the individual user. The analysis is be focused upon potential sequences extracted from the marketing data that include a partial sequence of marketing actions already engaged in with the individual user. In one approach, potential sequences are ranked based on similarities in characteristics of consumers associated with sequences that achieved a designated objective and the individual user. Characteristics used for the ranking include either or both of demographic details and behavioral information regarding the consumers and individual user. One or more top ranking sequences are identified and employed to determine one or more marketing actions to perform next to provide targeted marketing offers to the individual user. Then, the actions determined through the analysis are performed to complete the partial sequence for the individual user and deliver corresponding offers to the individual user.

In this manner, the particular sequence of interaction between a marketer and consumers may be tailored to consumers on an individual basis. Actions and marketing channels employed for contact with different individuals vary according to the sequences derived for the individuals. This increases the likelihood that users will act upon the offer and the objectives of the digital marketer will be achieved.

In the following discussion, an example environment is first described that may implement the techniques described herein. Example details regarding the techniques are then discussed in relation to some example scenarios, diagrams, and procedures. This discussion of example details includes separate sub-sections for example procedures, segmentation algorithms, and example user interfaces. Lastly, an example system and components of the system are discussed that may be employed to implement various techniques described herein.

Example Environment

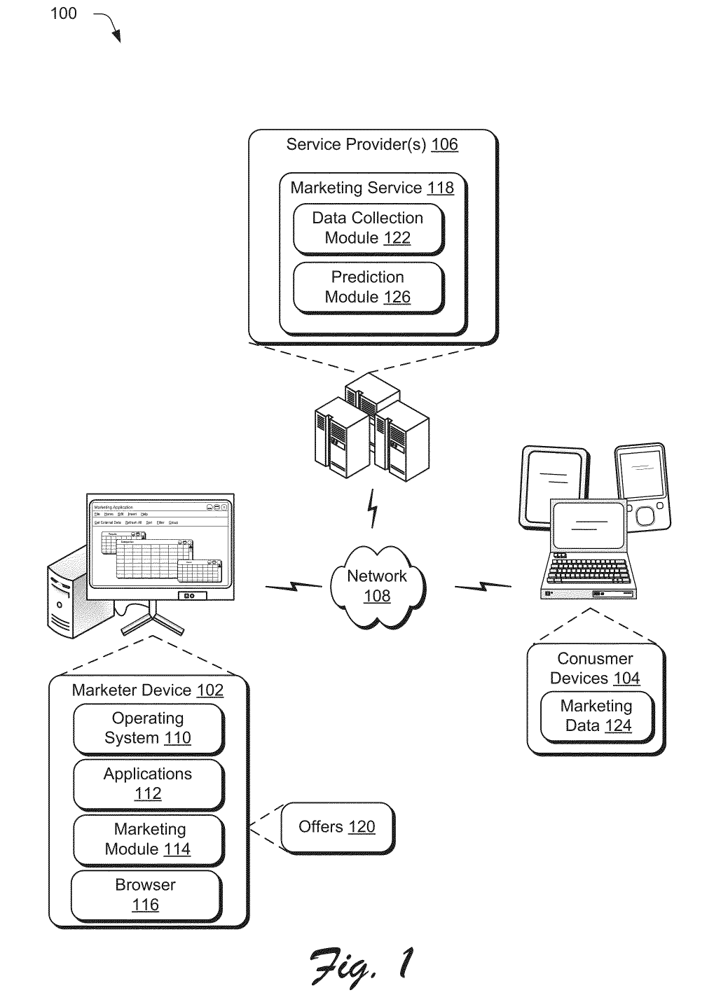

FIG. 1 is an illustration of an environment 100 in an example implementation that is operable to employ techniques described herein. The illustrated environment 100 includes a marketer device 102, one or more consumer devices 104, and a service provider 106 that are communicatively coupled via a network 108. The marketer device 102, consumer devices 104, and service provider 106 may each be implemented by one or more computing devices and also may be representative of one or more entities.

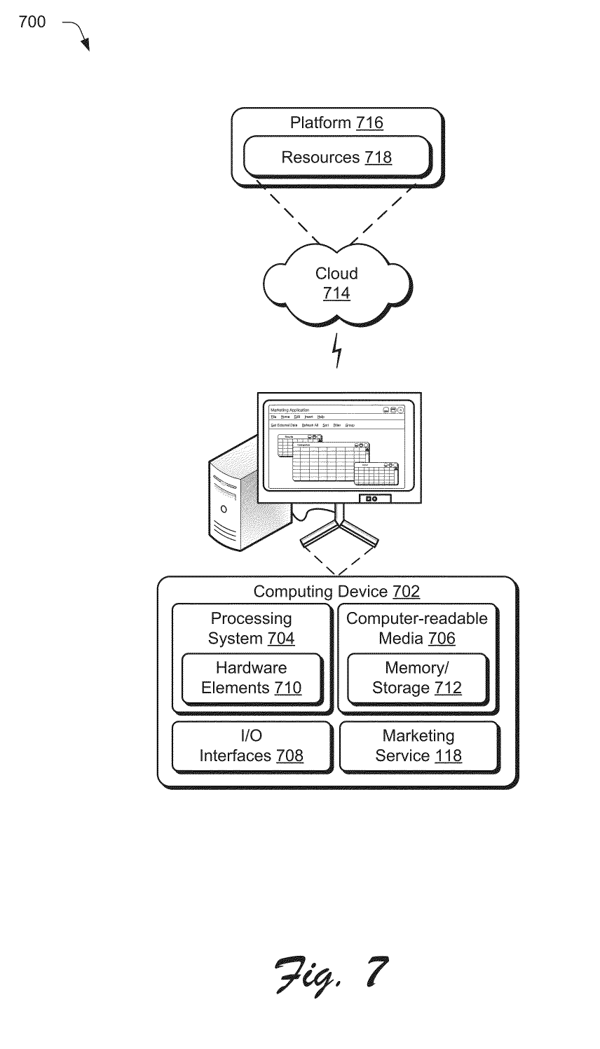

A computing device may be configured in a variety of ways. For example, a computing device may be configured as a computer that is capable of communicating over the network 108, such as a desktop computer, a mobile station, an entertainment appliance, a set-top box communicatively coupled to a display device, a wireless phone, a game console, and so forth. Thus, the computing device may range from full resource devices with substantial memory and processor resources (e.g., personal computers, game consoles) to a low-resource device with limited memory and/or processing resources (e.g., traditional set-top boxes, hand-held game consoles). Additionally, although a single computing device is shown in some instances, the computing device may be representative of a plurality of different devices, such as multiple servers of the service provider 106 utilized by a business to perform operations, and so on. Further examples of computing systems and devices suitable to implement techniques described herein are described below in relation to FIG. 7.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The marketer device 102 is further illustrated as including an operating system 110. The operating system 110 is configured to abstract underlying functionality of the underlying device to applications 112 that are executable on the client device 102. For example, the operating system 110 may abstract processing, memory, network, and/or display functionality such that the applications 112 may be written without knowing “how” this underlying functionality is implemented. The application 112, for instance, provides data to the operating system 110 to be rendered and displayed by a display device as illustrated without understanding how this rendering will be performed. A variety of applications 112 typically associated with devices are contemplated including, but not limited to, a document reader, a multi-media player, image editing software, a productivity suite that integrates multiple office productivity modules, games, and so forth. As specific example of applications 112, the marketer device 102 is also illustrated as including a marketing module 114 and a browser 116.

The marketing module 114 is configured in various ways to implement aspects of techniques for personalized marketing based on sequence mining described herein. As illustrated, the marketing module 114 may be provided as a standalone application that enables digital marketers to manage marketing campaigns, audience data, market segments, and so forth. In general, this includes marketing data collection, analysis of data to ascertain market segments of consumers having selected traits, creation of offers for products, services, and/or content, and distribution of the offers. The marketing module 114 also facilitates interaction with a marketing service 118 provided by the service provider 106 over the network. Thus, the marketing module 114 may represent a thin client web-based application or a web-enabled desktop application through which a digital marketer accesses a marketing account with the marketing service 118 and interact with corresponding data. In addition or alternatively, the techniques described herein may be implemented by way of the browser 116 configured to access the marketing service 118 over the network 108. Functionality of the marketing module 114 may also be integrated with the marketing service 118.

As noted, the service provider 106 provides a marketing service 118 as depicted in FIG. 1. The marketing service 118 implements an integrated digital marketing environment configured to provide a suite of digital marketing tools including but not limited to consumer data collection and analytics, social media management, digital advertising, audience targeting, and/or web experience management, to name a few examples. The marketing service 118 also enables generation of offers 120 that may be provided to consumers via consumer devices 104. The digital marketing environment also operates to individualize marketing actions taken with respect to different consumers as described in this document.

Offers 120 may include but are not limited to advertisements, links to other resources (services and content), digital coupons, informative (e.g., on-sale) offers, and promotional offers, to name a few examples. Offers 120 are provided via a plurality of different marketing channels, such as social networking, display ads, email, voicemail, instant messaging, marketing calls, and other types of interaction. Various digital marketing tools are made accessible via webpages or other user interfaces that are accessed and rendered by a marketing device 102. The marketing service 118 may be implemented in the “cloud” as a service accessible over the network as illustrated, by one or more distributed components in a client-server environment, as a locally deployed enterprise platform, and/or in another suitable manner.

In accordance with techniques described above and below, the marketing service 118 includes or otherwise makes use of a data collection module 122 that is configured to obtain and manipulate marketing data 124 from the consumer devices 104. In particular, the data collection module 122 represents functionality operable to collect, access, and/or make use of marketing data 124 that is indicative of online consumer interaction with offers. Generally, marketing data 124 includes user characteristics (e.g., age, sex, location, affiliations, etc.) and behaviors (e.g., browsing habits, favorites, purchase history, preferences, account activity, page views, offer views, etc.) from the various consumers. Marketing data 124 also includes sequencing data that is indicative of the types of marketing channels used with respect to offers/campaigns and the order in which channels were employed. The data collection module 122 collects and stores marketing data 124 on behalf of digital marketers. For example, marketing data 124 may be collected based on visitors to a company website, in response to ads placed on third party webpages, through online surveys, as part of e-commerce transactions, based on account sign-ups, and so forth.

In addition to collection of marketing data, the marketing service 118 is configured to utilize marketing data in various ways to inform digital marketers regarding user activities and facilitate creation of effective marketing strategies and campaigns. One such example of analysis involves techniques for personalized marketing based on sequence mining described in this document. For example, the marketing service 118 may include or otherwise make use of a prediction module 126 that represents functionality operable to analyze marketing data 124 to develop individualized marketing strategies for individual consumers based on data regarding sequences of marketing actions that worked with other consumers. By way of example and not limitation, the prediction module 126 includes functionality to automatically identify one or more potential sequences for an individual user to achieve an objective for targeted marketing to that user (e.g., purchasing a product, visiting a website, sign-up for a service, etc.). To do so, the prediction module 126 parses the marketing data 124 to select potential sequences associated with other individuals that resulted in satisfaction of the same objection. In one approach, potential sequences are selected that include a partial sequence of actions already engaged in with the individual user that is the target of the analysis. A sequence(s) and corresponding marketing actions that are most likely to cause the individual user to respond in a way that satisfies the objective are determined based on similarity analysis between the individual user and consumers associated with the potential sequences. Examples and details regarding these and other aspects are discussed in relation to the following figures.

Having considered an example environment, consider now a discussion of some example details of techniques for personalized marketing based on sequence mining in accordance with one or more implementations.

Personalized Marketing Based on Sequence Mining Details

Example Scenarios

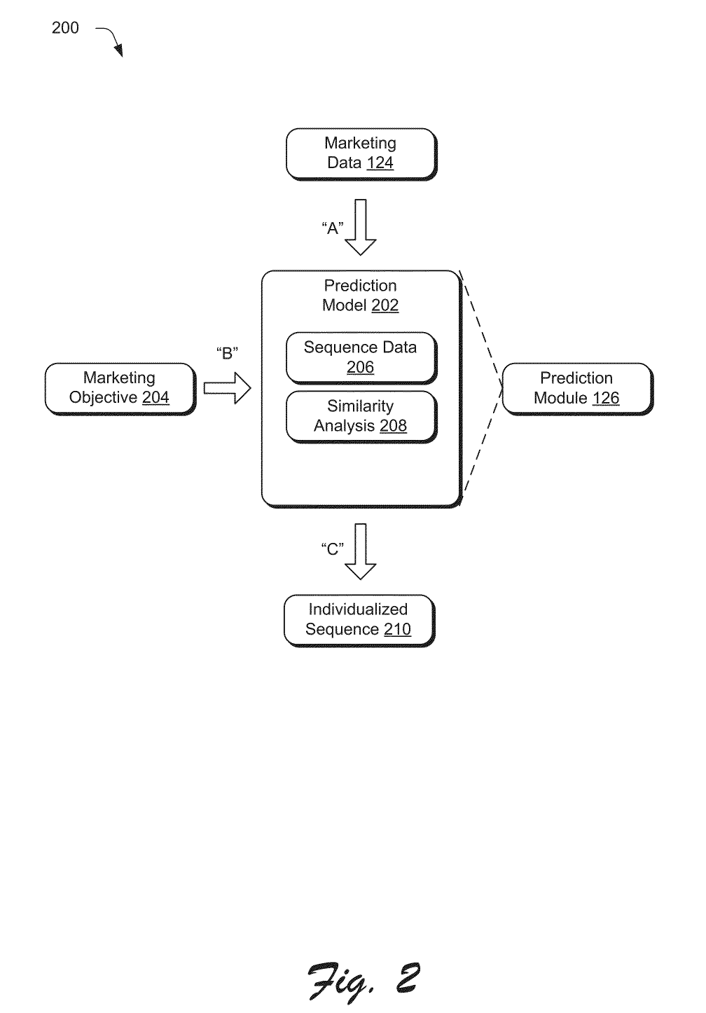

To further illustrate details of the example techniques, consider now FIG. 2 which depicts generally at 200 a diagram that represents an example scenario for in accordance with one or more implementations. In particular, FIG. 2 represents a sequence of example operations that may be performed to determined individualized interaction sequences for targeted marketing to consumer. The individualized interaction sequences are derived by mining marketing data 124 to generate sequence data for past interactions of marketers with consumers. Given a marketing objective, such as purchase of a particular product or making a purchase from a certain merchant site, potential sequences associated with satisfaction of the objective are extracted from the marketing data 124 and analyzed to match sequences to a selected individual based on various criteria. The best sequence or group of sequences that are matched most closely to the target individual are returned as a result. Performance of corresponding marketing actions is then initiated with respect to the selected individual to provide targeted marketing.

In this context, some example operations are indicated in FIG. 2 using letters “A” to “D”. In the discussion, reference may be made to the example environment, devices, and components discussed in relation to FIG. 1. At “A”, marketing data 124 collected from consumer devices 104 is provided as input to a prediction model 202 that is instantiated via prediction module 126. In addition at “B” a marketing objective 204 for the analysis is specified. Marketing objective 204 corresponds to a behavior that the marketer would like consumers to exhibit in response to offers 120 and/or campaigns. By way of example and not limitation, marketing objectives may relate to purchase activity, browsing/internet behavior, social network actions, user subscriptions, offer acceptance, provision of requested data, or survey completion, to name a few examples.

The prediction model 202 operates to perform analysis of the collected marketing data 124. For example, the prediction model 126 parses the collected data to obtained sequence data 206. Sequence data 206 that is mined from the marketing data 124 describes sequencing for the marketing offers provided to consumers. In particular, sequencing data 206 indicates marketing actions, the order of marketing actions, and marketing channels employed to provide offers 120 or otherwise contact consumers. The sequencing data 206 also provides indications of objectives defined for sequences and whether or not the objectives were met. In addition, the prediction model 202 also utilizes marketing and/or sequencing data to ascertain a partial sequence of actions engaged in with respect to an individual user who is the subject of the analysis.

Prediction model 202 further operates to perform similarity analysis 208, which involves assessing similarities between an individual user and consumers associated with potential sequences derived from the sequencing data 206. The prediction model 202 is configured to extract sequences that resulted in satisfaction of the marketing objective to use as potential sequences. Additionally, the potential sequences may be selected as sequences that contain the partial sequence of actions engaged in with respect to an individual user. By so doing, the analysis is focused upon a set of potential sequences that satisfy the marketing objective 204 and include the partial sequence of actions. In this context, the similarity analysis 208 is configured to ascertain one or more additional marketing actions to complete the partial sequence and thereby generate an individualized sequence 210 as represented at “C”. The individualized sequence 210 is derived to maximize the probability that the individual user will respond to the sequence with behavior(s) that also satisfies the marketing objective 204.

Similarity analysis 208 may be performed in any suitable way to distinguish between potential sequences accordingly to selected criteria. Generally, the similarity analysis 208 involves applying an algorithm to score and/or rank potential sequences one to another using the selected criteria. Then, actions associated with potential sequences deemed as being the most favorable according to the similarity analysis (e.g., best scores, highest ranks, most similarity to target user) are selected to complete the partial sequence and form the individualized sequence 210.

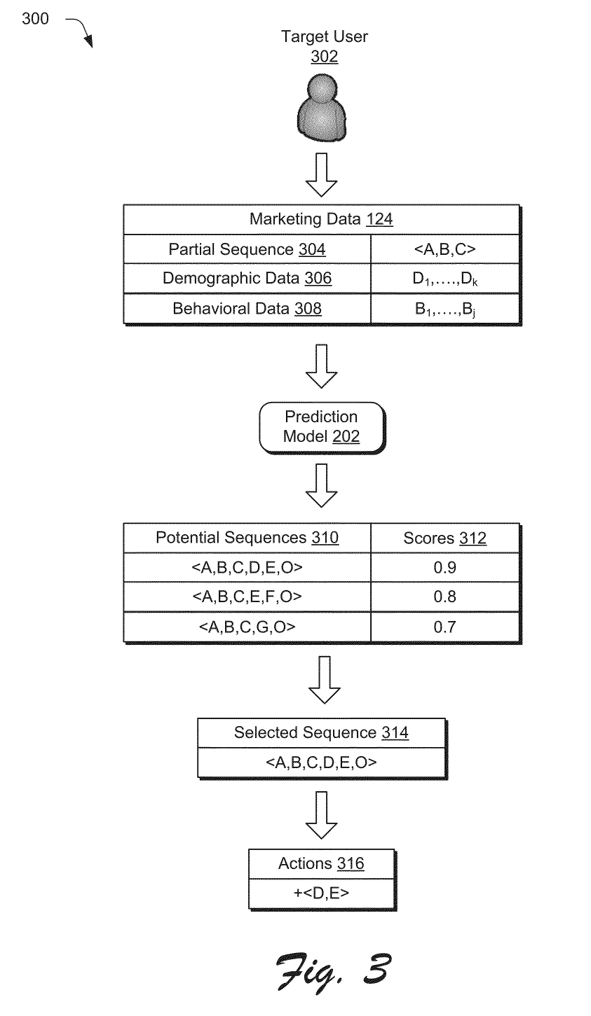

Further details regarding similarity analysis and operations to identify one or more marketing actions to complete a partial sequence of actions engaged in with respect to an individual user are described in relation to FIG. 3. In particular, FIG. 3 depicts generally at 300 a diagram that represents an example scenario in accordance with one or more implementations. In this example, analysis of marketing data 124 is performed to derive an individualized sequence for a target user 302. The marketing data 124 includes a partial sequence 304 of marketing actions previously performed with respect to the target user 302. Partial sequence 304 in this example include a series of actions denoted as “<A, B, C>”.

In addition, marketing data 124 obtained as input to the analysis includes characteristics of the target user 302 as well as other consumers used to assess similarity. The characteristics include but are not limited to one or more of demographic data 306 or behavioral data 308 as represented in FIG. 3. Various individual demographic field-value combinations D₁, . . . , Dₖ are included in the demographic data 306. Likewise, various individual behavioral field-value combinations B₁, . . . , Bⱼ are included in the behavioral data 308.

The marketing data 124 including the partial sequence 304, demographic data 306, and behavioral data 308 is fed in the prediction model 202. The prediction model 202 uses this data to identify and extract potential sequences 310. Each of the potential sequences 310 may include the partial sequence 304 of actions already engaged in with respect to the target user 302. The sequences may additionally correspond to prior consumer interaction that satisfied a marketing objective 204 defined for the targeted marketing to the individual user. The marketing objective is denoted by “O” within the potential sequences 310 shown in FIG. 3. In particular, potential sequences <A, B, C, D, E, O>, <A, B, C, E, F, O>, and <A, B, C, G, O> are represented in the example of FIG. 3. Note that each of these example sequences includes the partial sequence 304 of <A, B, C> and results in attainment of the objective, O.

The prediction model 202 assesses similarity between potential sequences extracted from the collected marketing data and the individual user being evaluated. In one approach, similarity is assessed by matching of characteristics of the individual user to characteristics of consumers associated with the potential sequences. The characteristics include demographic data and/or behavior data regarding the individual user and the consumers. By way of example, the prediction model 202 may operate to calculate scores 312 for the one or more potential sequences based on similarity analysis that compares the various characteristics. The prediction model 202 then ranks the one or more potential sequences one to another according to the scores as shown in FIG. 3.

A selected sequence or sequences are selected from among the one or more potential sequences according to the ranking. For example, the selected sequence 314 is shown as sequence <A, B, C, D, E, O> in FIG. 3. Here, the selected sequence 314 has a score (e.g., 0.9) that ranks the sequence above other potential sequences. Therefore, the selected sequence 314 is selected as the “best” candidate. The scoring and ranking is designed to identify a sequence that has the highest likelihood of causing desired behavior of the target user 302.

The selected sequence 314 is used to determine the actions 316 to be taken with respect to the user to complete the partial sequence 304. The actions 316 are actions included in the selected sequence 314 that are yet to be taken with respect to the target user 302. These actions are identified by removing the partial sequence and objective from the selected sequence 314. Actions 316 in FIG. 3 are represented as +<D, E>, which indicates that actions D and E are to be added to the partial sequence 304.

The prediction model 202 may output a result of the analysis in any suitable format that is configured to indicate the selected sequence 314 and/or the actions 316. The prediction model 202 also initiates operations to perform the actions 316. By way of example and not limitation, the prediction model may configure and output a control message indicative of the one or more marketing actions identified to complete the partial sequence. The control message is effective to cause performance of the one or more marketing actions via a marketing service 118 or marketer module 114 to provide targeted marketing offers to the individual user.

Example Algorithm

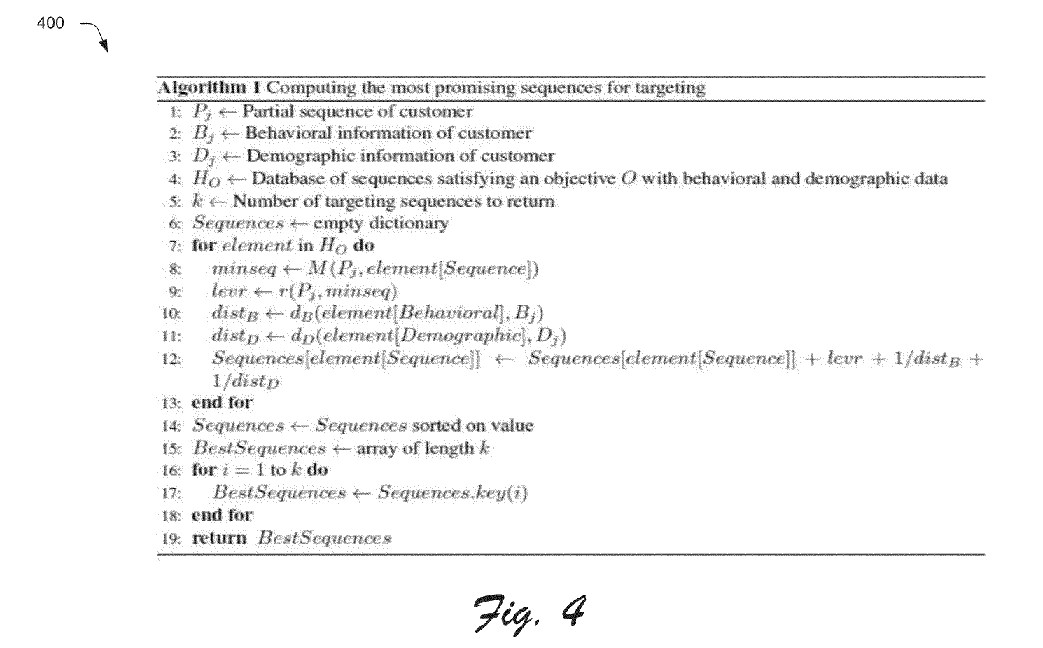

In accordance with the foregoing discussion, one illustrative example algorithm that reflects the general principals and concepts discussed herein is represented in relation to FIG. 4. Given the historic interaction information of an individual user along with the user's demographic and behavioral data, the example algorithm is designed to make comparisons to a database of sequences (e.g. marketing data 124) that satisfy the objective of the marketer (D(O)). Based on a notion of similarity, the algorithm operates to generate a ranked list of one or more sequences containing the individual's partial sequence that are most likely to achieve the marketer's goal. The number of sequences to select is configurable. The resultant list can be used to target the customer with appropriate actions from one or more of the sequences that are likely to achieve the defined objective.

The notion of similarity is encompassed by the example algorithm as follows. For a partial sequence Pⱼ contained in another sequence Sᵢ=<I₁, I₂, . . . , Iᵢ_{ₖ}>, define the minimum super-sequence Sᵢ*=<I₁, I₂, . . . , Iᵢ_{ₗ}> of Pⱼ, such that Sᵢ* contains Pⱼ and iₗ is the smallest number that satisfies this condition. For example, the minimum super-sequence <A, B, D> in <A, B, C, D, E> is <A, B, C, D>. For Pⱼ and Sᵢ, let the function M(Pⱼ, Sᵢ) return the minimum super-sequence of Pⱼ in Sᵢ. Then, for a marketing objective O, marketing data 124 is parsed to derive a filtered list, data structure or database of sequences H_{O}={(Sᵢ, Dᵢ₁, . . . , Dᵢₗ, Bᵢ₁, . . . , Bᵢₖ)}, ∀i such that sequences Sᵢ ends in the objective O. Let d_{D}(x,y) and d_{B}(x,y) denote the appropriate distance metrics for demographic and behavioral features (one example may be the Euclidian distance). Define the sigmoidal function T(α)=2/(1+exp(α)), which goes to 0 as α→∞, and goes to 1 as α→0. Also, the Levenshtein Ratio denoted by the function r(x,y) between two strings x and y is a measure of similarity between two strings.

In this context, the example algorithm of FIG. 4 may be employed to score and rank potential sequences one to another, as indicated by lines 5-13 of the example algorithm. A configurable number of top ranking sequences for the algorithm to return is defined by k (line 5) and an empty set of sequences is initialized to contain the results (line 6). For each element in H_{O} (line 7), the value of minseq is computed for the minimum super-sequence of Pⱼ in Sᵢ as noted above (line 8). Then values of levr for the Levenshtein Ratio for sequence similarity of the Pⱼ and minseq (line 9), and dist_{B} and dist_{D} (lines 10 and 11) to reflect behavioral and demographic similarity between the target user and consumer associated with Sᵢ are computed. These values are combined to produce scores for each respective sequences. Various different scoring computations that combine the similarity factors in different ways are contemplated. In the example of FIG. 4, the sequence scores for each element are computed by additively combining the factors according to the expression levr+1/dist_{B}+1/dist_{D} (line 12). The scores are used to sort the sequences one to another into a ranked list and then, an array of length k is provided as a result to return k sequences that are the mostly likely to produce the objective O with the target user. Further details are discussed in relation to the following example procedures.

Example Procedures

The following discussion describes example procedures that may be implemented utilizing the previously described systems and devices. The procedures represent example techniques to individualize marketing actions taken with respect to different consumers within a digital marketing environment for management of digital marketing campaigns to provide online marketing offers to consumers. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1 and the examples of FIGS. 2-4. In at least some embodiments, the procedures may be performed by a suitably configured computing device(s), such one or more server devices associated with the service provider 106 that implement a marketing service 118 and/or a marketer device 102 of FIG. 1 that includes a suitable marketing module 114 or browser 116 to implement the described techniques.

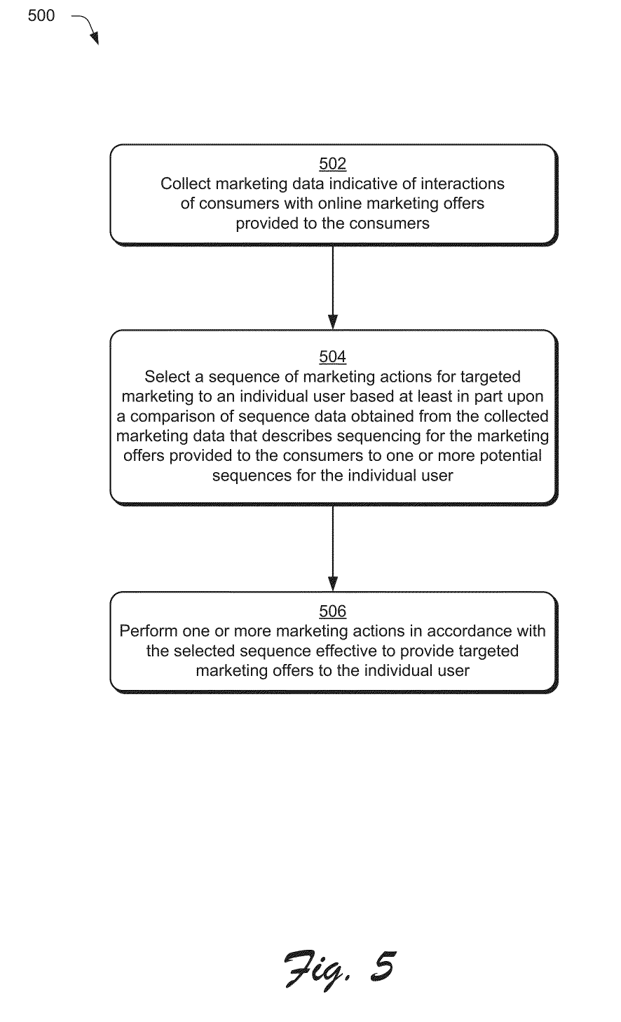

FIG. 5 is a flow diagram depicting an example procedure 500 in which sequence data is used to select marketing actions in accordance with one or more implementations. Marketing data is collected that is indicative of interactions of consumers with online marketing offers provided to the consumers (block 502). For example, a marketing service 118 may collect various marketing data 124 via a collection module 122 or otherwise. As mentioned, the marketing data 124 describes characteristics of actual consumer interactions with offers from digital marketers associated with webpages and/or other resources accessed by the users connection with resources available from one or more service providers. The marketing data 124 also reflects sequence data 206 used to evaluate additional actions to take with respect to a target user 302. Marketing offers may be provided via multiple different channels and the sequence data 206 indicates the order in which the multiple channels are used for targeted marketing.

In particular, a sequence of marketing actions for targeted marketing to an individual user is selected based at least in part upon a comparison of sequence data obtained from the collected marketing data that describes sequencing for the marketing offers provided to the consumers to one or more potential sequences for the individual user (block 504). For example, sequence data 206 indicated by marketing data 124 may be employed to perform similarity analysis 208 in the manner previously described. The similarity analysis involves scoring potential sequences based on one or more of (1) similarity of a sequence to a partial sequence for a user being evaluated and (2) similarity in characteristics of the user being evaluated to a consumer associated with a potential sequence being scored. As mentioned, characteristics that are evaluated for similarity include either or both of behavioral or demographic characteristics. Additionally, the potential sequences evaluated may each include the partial sequence of actions already engaged in with respect to the individual user. Other notions suitable to assess similarity are also contemplated. Thus, one or more similarity factors including but not limited to factors for sequence, behavioral, and/or demographic similarity are computed and combined to produce an overall similarity score for potential sequences.

The potential sequences are sorted, filtered, ranked or otherwise manipulated based on the scores to produce an ordered set of sequences. A sequence of marketing actions to take next with respect to the target user is then selected using the ordered set of sequences. For example, actions associated with a highest ranked sequence may be selected to complete the partial sequence for the user being evaluated. In another approach, actions derived from a group of two or more of the ranked sequences are selected to create a completed sequence for the user. This approach enables multiple different actions identified as being successful with different consumers (based on satisfaction of the objective) to be tried in combination with the target user (or in different combinations with different users). For instance, if different actions were successful with different users with a relatively low success rate (e.g., below some scoring threshold), the system may be configured to select and try some of these different actions in combination with one another.

Then, one or more marketing actions are performed in accordance with the selected sequence effective to provide targeted marketing offers to the individual user (block 506). For example, a marketing service 118 may perform the one or more actions that are selected, such as by directly sending offers 120 to a consumer device 104. In addition or alternatively, the marketing service 118 may cause performance of the selected actions by a marketing module 114 associated with a marketer device 102. In an example, the marketing service 118 sends a control message or other suitable communication to initiate performance of the actions. The control message is configured to indicate the one or more marketing actions identified to complete the partial sequence and is also effective to cause performance of one or more marketing actions to provide targeted marketing offers to the individual user. Performance of the one or more marketing actions involves interactions between the marketer/marketing service and the target users to provide offers 120 using particular marketing channels and in the order specified by the selected sequence identified from the analysis.

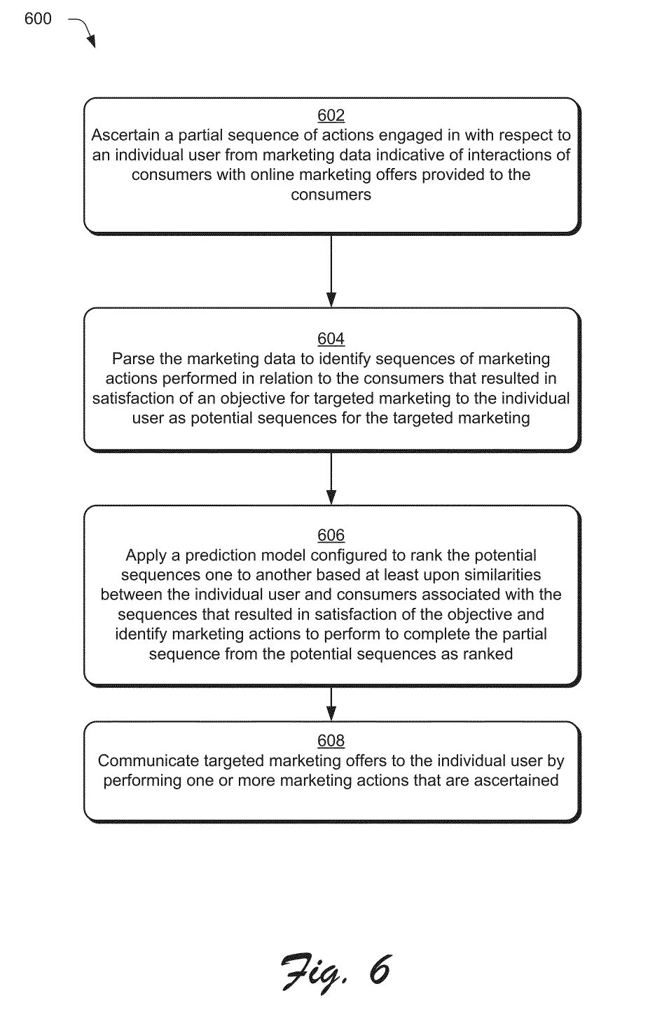

FIG. 6 is a flow diagram depicting an example procedure 600 in which a prediction model is applied to rank potential sequences and ascertain marketing actions to perform in accordance with one or more implementations. A partial sequence of actions engaged in with respect to an individual user are ascertained from marketing data indicative of interactions of consumers with marketing offers provided to the consumers (block 602). For example, a marketing service 118 operates to obtain information regarding a target user from a database of marketing data 124 maintained by or otherwise accessible to the marketing service 118. The marketing data 124 reflects marketing actions that have been taken with respect to the target user as well as behavioral, demographic, and other characteristics data associated with the target user. Thus, the marketing data 124 may be used to obtain a partial sequence of actions already engaged in with respect to the individual target user.

Additionally, the marketing data is parsed to identify sequences of marketing actions performed in relation to the consumers that resulted in satisfaction of an objective for targeted marketing to the individual user as potential sequences for the targeted marketing (block 604). For example, a marketing service 118 further analyzes marketing data to identify and/or extract sequences that attained a marketing objective defined for the target user who is being assessed. For instance, the objective may be to get the target user to purchase a particular produce or spend a designated amount (e.g., $150 or more). Accordingly, the database is parsed to find matching sequences that resulted in a consumer purchasing the product or spending the designated amount.

A prediction model is applied that is configured to rank the potential sequences one to another based at least upon similarities between the individual user and consumers associated with the sequences that resulted in satisfaction of the objective and identify marketing actions to perform to complete the partial sequence from the potential sequences as ranked (block 606). For example, a prediction model 202 is implemented to perform similarity analysis 208 as discussed in relation to FIG. 2. Generally, the prediction model 202 is configured to identify individualized sequences 210 for target users based on mining of sequence data 206 and consumer characteristics indicated by collected marketing data. The similarity analysis 208 determines similarities between the individual user and consumers by comparing at least demographic and behavioral characteristics of the individual user with the consumers as noted previously. The analysis may also involve comparisons to assess similarities between sequences, such as assessing similarity between one or more potential sequences and a partial sequence for a target user as also discussed previously. By way of example and not limitation, the similarity analysis 208 may occur in accordance with the example scenarios discussed in relation to FIG. 2 and/or FIG. 3. Moreover, the similarity analysis 208 may be performed using a suitable algorithm that reflects the prediction model, such as the example algorithm discussed in relation to FIG. 4.

The similarity analysis produces a ranking of potential sequences as a result of the analysis employed to identify marketing actions to perform to complete the partial sequence. Then, targeted marketing offers are communicated to the individual user by performing one or more marketing actions that are ascertained to complete the partial sequence (block 608). The marketing service 118 may therefore perform or initiate the actions that are identified. In particular, the completion of the partial sequence indicates additional actions that have not yet been taken with respect to the individual user. The sequence also specifies the order and/or timing in which the actions are to be taken. Additionally, the sequence may provide indications of marketing channels to be used for the actions. Thus, one or more identified actions are taken in accordance with the order, timing, and/or marketing channels that are specified.

The actions may correspond to sending of offers 120 to a target user on behalf of a marketer. The marketing service 118 is configured to prepare and communicate such offers corresponding to the identified actions. In addition or alternatively, the marketing service 118 may generate and communicate control messages or other suitable communications to initiate performance of the actions. For example, a control message may be configured to direct a marketing module 114 of a marketer device 102 (or a marketing module 114 associated with the marketing service 118) to perform action indicated by the control message. Communication of targeted marketing offers to an individual consumer may involve using a least two or more different marketing channels to contact the individual user as indicated by the completed sequence derived for the individual user.

Having consider the foregoing example details, consider now a discussion of an example system and devices that may be employed for aspects of techniques for personalized marketing based on sequence mining in one or more implementations.

Example System and Devices

FIG. 7 illustrates an example system generally at 700 that includes an example computing device 702 that is representative of one or more computing systems and/or devices that may implement the various techniques described herein. This is illustrated through inclusion of the marketing service 118, which may be configured to provide a suite of digital marketing tools to users of the service. Alternatively, the computing device may represent a client device that includes a marketing module 114 or browser 116 to implement aspects of the described techniques. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable storage of information in contrast to mere signal transmission, carrier waves, or signals per se. Thus, computer-readable storage media does not include signal bearing media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although aspects have been described herein in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. In a digital marketing environment for management of digital marketing campaigns to provide online marketing offers to consumers, a method to individualize marketing actions taken with respect to different consumers comprising:
collecting marketing data indicative of interactions of the consumers with online marketing offers provided to the consumers;
selecting a sequence of marketing actions for targeted marketing to an individual user by comparing sequence data obtained from the collected marketing data that describes sequencing for the marketing offers provided to the consumers to one or more potential sequences for the individual user; and
performing one or more marketing actions in accordance with the selected sequence effective to provide targeted marketing offers to the individual user.

2. A method as described in claim 1, wherein the marketing offers comprise offers from digital marketers that are provided via webpages accessed by users in connection with resources available from one or more service providers.

3. A method as described in claim 1, wherein the marketing offers are provided via multiple channels and the sequence data indicates the order in which the multiple channels are used for targeted marketing.

4. A method as described in claim 1, wherein the comparison comprises an assessment of similarity between sequences within the collected marketing data that satisfied an objective defined for the targeted marketing to the individual user and the one or more potential sequences for the individual user.

5. A method as described in claim 4, wherein the assessment of similarity is further based upon matching of characteristics of the individual user to characteristics of consumers associated with the sequences that satisfied the objective defined for the targeted marketing to the individual user.

6. A method as described in claim 5, wherein the characteristics that are matched include behaviors associated the individual user and the consumers.

7. A method as described in claim 5, wherein the characteristics that are matched include demographic data regarding the individual user and the consumers.

8. A method as described in claim 1, wherein selecting the sequence further comprises:
calculating scores for the one or more potential sequences based on the comparison;
ranking the one or more potential sequences one to another according to the scores; and
selecting the sequence from among the one or more potential sequences according to the ranking.

9. A method as described in claim 1, wherein the one or more potential sequences each include a partial sequence of actions already engaged in with respect to the individual user.

10. A method as described in claim 1, wherein the method is performed by a marketing service made accessible to digital marketers over a network via a service provider.

11. One or more computer-readable storage media comprising instructions that, when executed by a computing device, implement a marketing service configured to perform operations to individualize marketing actions taken with respect to different consumers comprising:
ascertaining a partial sequence of actions engaged in with respect to an individual user from marketing data indicative of interactions of the consumers with marketing offers provided to the consumers;
parsing the collected marketing data to identify sequences of marketing actions performed in relation to the consumers that resulted in satisfaction of an objective for targeted marketing to the individual user as potential sequences for the targeted marketing;
applying a prediction model configured to:
rank the potential sequences one to another based at least upon similarities between the individual user and consumers associated with the sequences that resulted in satisfaction of the objective; and
ascertain marketing actions to perform to complete the partial sequence from the potential sequences as ranked; and
communicating targeted marketing offers to the individual user by performing one or more marketing actions that are ascertained to complete the partial sequence.

12. One or more computer-readable storage media of claim 11, wherein similarities between the individual user and consumers are determined by comparing demographic and behavioral characteristics of the individual user with the consumers.

13. One or more computer-readable storage media of claim 11, wherein the objective for targeted marketing to the individual user comprises purchasing of a product associated with the marketing offers.

14. One or more computer-readable storage media of claim 11, wherein communicating the targeted marketing offers comprises using two or more different marketing channels to contact the individual user.

15. One or more computer-readable storage media of claim 11, wherein the marketing service is further configured to perform operations to collect the marketing data indicative of consumer interaction with the marketing offers, the marketing data related to user demographics, user's behaviors, and characteristics of web content and other resources accessed by users in connection with the marketing offers.

16. In a digital marketing environment for management of digital marketing campaigns to provide online marketing offers to consumers, a computing system comprising:
a processing system;
one or more computer-readable media storing instructions that, when executed by the processing system, implement a marketing service configured to individualize marketing actions taken with respect to different consumers including:
a data collector configured to collect marketing data indicative of consumer interaction with marketing offers, the marketing data including at least sequencing data, demographic data, and behavior data corresponding to the marketing offers;
a prediction model configured to identify one or more marketing actions to complete a partial sequence of actions engaged in with respect to an individual user and satisfy an objective defined for targeted marketing to the individual user, the one or more marketing actions identified by ranking potential sequences of marketing actions indicated by the sequencing data according to values computed using the demographic data and the behavior data that reflect similarities in characteristics between consumers associated with the potential sequences and the individual user.

17. The computing device of claim 16, wherein the digital marketing environment is configured to provide a suite of digital marketing tools.

18. The computing device of claim 16, wherein the potential sequences of marketing actions each include the partial sequence of actions engaged in with respect to the individual user.

19. The computing device of claim 16, wherein the prediction model is further configured to output a control message indicative of the one or more marketing actions identified to complete the partial sequence, the control message effective to cause performance of one or more marketing actions to provide targeted marketing offers to the individual user.

20. The computing device of claim 16, wherein the marketing service further includes a marketing module operable to communicate offers to consumers via a plurality of marketing channels.
